(19) United States
(12) Patent Application Publication
(10) Pub. No.: US 2023/0084791 A1
(43) Pub. Date: Mar. 16, 2023

(54) HARDWARE ARCHITECTURE TO ACCELERATE GENERATIVE ADVERSARIAL NETWORKS WITH OPTIMIZED SIMD-MIMD PROCESSING ELEMENTS

(71) Applicant: Intel Corporation, Santa Clara, CA (US)

(72) Inventor: Kamlesh Pillai, Bangalore (IN)

(21) Appl. No.: 18/058,114

(22) Filed: Nov. 22, 2022

(51) Int. Cl. G06N 3/04; G06F 9/38

(52) U.S. Cl. CPC G06N 3/0454; G06F 9/3887

(57) ABSTRACT

Systems, apparatuses and methods may provide for technology that includes transformation hardware to convert input data from a time domain into a frequency domain, a generative model, and a discriminative model coupled to the transformation hardware and the generative model, wherein the generative model and the discriminative model are to operate in the frequency domain.

### TECHNICAL FIELD

Embodiments generally relate to artificial intelligence (AI) computing. More particularly, embodiments relate to a hardware-based AI computing architecture to accelerate generative adversarial networks (GANs) with optimized single instruction multiple data (SIMD) and multiple instruction multiple data (MIMD) processing elements.

### BACKGROUND OF THE DISCLOSURE

Deep learning plays a significant role in artificial intelligent (AI) and machine learning (ML) research, and many models have been developed based on generative adversarial networks (GANs). A GAN is typically an unsupervised learning solution that is based on zero-sum game theory for two players. More particularly, a generative network (e.g., player one) uses convolution (e.g., sliding window) operations to generate candidates, while a discriminative network (e.g., player two) uses convolution operations to evaluate the candidates from the generative network. Typically, the generative network learns to map from a latent space to a true data distribution and the discriminative network distinguishes candidates produced by the generative network from the true data distribution. The training objective of the generative network is to increase the error rate of the discriminative network (e.g., “fool” the discriminator network by producing novel candidates that the discriminator network identifies as not synthesized and therefore part of the true data distribution). While GANs may be useful in the areas of computer vision, image classification, speech and language processing, there remains considerable room for improvement. For example, conventional GANs may be inefficient and have relatively high compute and memory requirements.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a zero insertion operation according to an embodiment;

FIG. 2 is a set of charts of an example of ineffectual operations and zero value percentages in a conventional generative adversarial network (GAN);

FIG. 3 is a block diagram of an example of a GAN accelerator according to an embodiment;

FIG. 4 is a comparative chart of an example of a conventional number of operations in a GAN accelerator and a number of operations in a GAN accelerator according to an embodiment;

FIG. 5 is a schematic diagram of an example of a model architecture according to an embodiment;

FIG. 6 is a schematic diagram of an example of a processing element according to an embodiment;

FIG. 7 is a schematic diagram of an example of address generation hardware according to an embodiment;

FIG. 8 is a plot of an example of COrdinate Rotation Digital Computer (CORDIC) convergence according to an embodiment;

FIG. 9 is a schematic diagram of an example of CORDIC hardware according to an embodiment;

FIG. 10 is a flowchart of an example of a method of setting bypass bits according to an embodiment;

FIG. 11 is a block diagram of an example of a systolic array according to an embodiment;

FIG. 12 is a schematic diagram of an example of a multiplier unit with scaling factor input according to an embodiment;

FIG. 13 is a schematic diagram of an example of a multiplier unit with cosine value input according to an embodiment;

FIG. 14 is a schematic diagram of an example of discrete cosine transform (DCT) hardware according to an embodiment;

FIG. 15 is a flowchart of an example of a method of operating a GAN accelerator according to an embodiment;

FIG. 16 is a flowchart of an example of a method of operating a model architecture according to an embodiment;

FIG. 17 is a flowchart of an example of a method of operating a processing element according to an embodiment;

FIG. 18 is a block diagram of an example of a performance-enhanced computing system according to an embodiment; and

FIG. 19 is an illustration of an example of a semiconductor package apparatus according to an embodiment.

### DETAILED DESCRIPTION

Traditional generative adversarial networks (GANs) usually include two versions of a deep neural network (DNN) model: a generative model and a discriminative model. Accordingly, the overall computation requirement for GANs may double as compared to traditional DNNs.

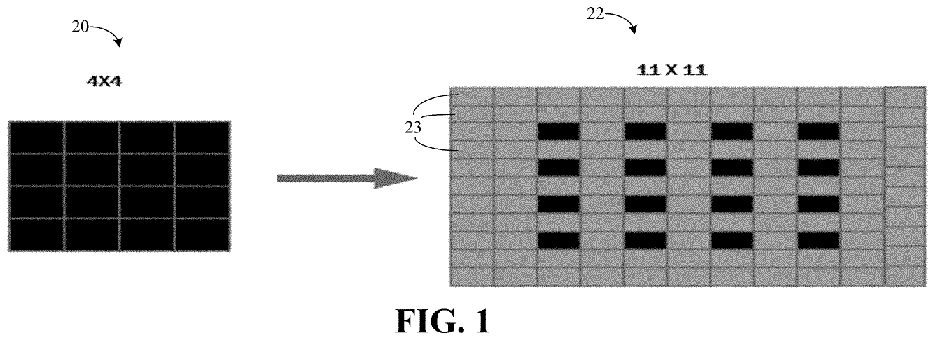

Additionally, FIG. 1 demonstrates that the generative model typically uses transposed convolution (transconv) to produce “fake” output data 22 in an attempt to fool the discriminative model, which uses traditional convolution. The transposed convolution includes a zero insertion operation on an input value 20 from a random number generator, wherein the fake output data 22 is of a certain dimension (e.g., 11×11) and contains zero values 23.

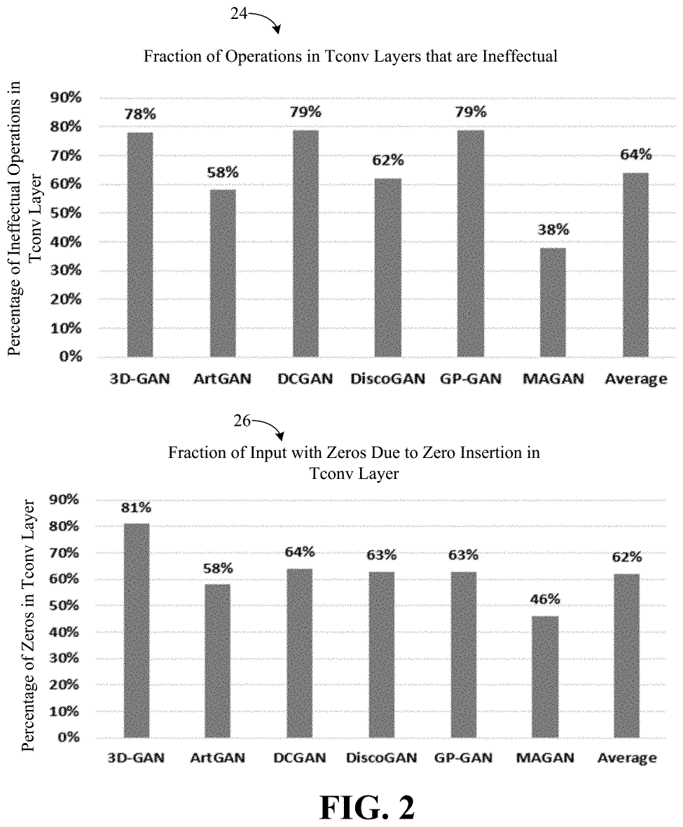

FIG. 2 shows a first chart 24 demonstrating that the zero insertion operation of FIG. 1 creates ineffectual operations in the network. Additionally, a second chart 26 demonstrates that the percentage of zeros in the transconv layer is significant. Therefore, the zero insertion operation creates a compute imbalance (e.g., due to sparsity), which leads to substantial computation inefficiencies. As will be discussed in greater detail, the technology described herein provides an enhanced hardware (e.g, circuitry) accelerator architecture that solves the high compute requirement and compute imbalance problems without increasing the overall memory cost, power consumption or chip area.

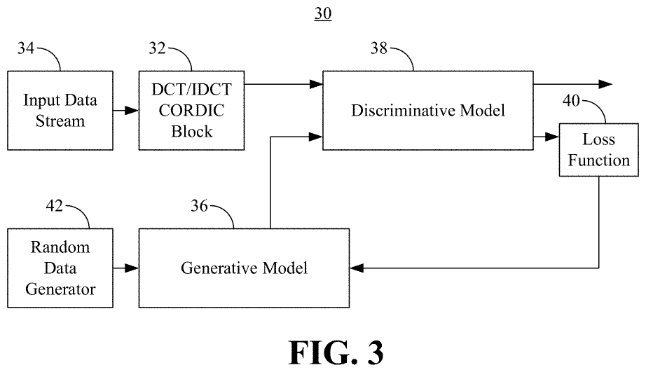

FIG. 3 shows a GAN accelerator 30 that automatically generates larger and richer datasets from input data 34 (e.g., relatively small labeled set during training) and is effective in various applications (e.g., computer vision, image classification, speech and language processing). The GAN accelerator 30 includes transformation hardware 32 (e.g., discrete cosine transform/DCT and inverse DCT/IDCT CORDIC block) that converts the input data 34 from the time domain into the frequency domain. The GAN accelerator 30 also includes a generative model 36 (e.g., DNN) and a discriminative model 38 coupled to the transformation hardware 32 and the generative model 36. In an embodiment, the GAN accelerator 30 includes a random number generator 42 coupled to the generative model 36, wherein the random number generator 42 inserts zero values into an output to the generative model 36, as well as a loss function generator 40 coupled to the discriminative model 38 and the generative model 36. The generative model 36 and the discriminative model 38 operate in the frequency domain.

More particularly, the conversion of the input data 34 using DCT is very minimal compared to traditional solutions. As will be discussed in greater detail, the proposed architecture separates data retrieval and data processing for each processing element (PE) within the models 36, 38. Embodiments use a CORDIC procedure to implement cosine functions used in DCT/IDCT computation of floating point numbers. The CORDIC procedure may be implemented using a systolic array to reduce latency. In one example, look-up tables (LUTs) are not required in implementing the CORDIC procedure and only a single multiplier may be used to obtain the final product term, which translates into significant amount of area saving. Because of simplified implementation of CORDIC using the systolic array, computation takes only 2N−1 clock cycles to compute cosine values for N×N DCT/IDCT.

In one example, the CORDIC procedure includes an iteration of eight stages to increase accuracy. Results may be achieved with a relatively low approximation error due a scaling factor being used, which does not degrade the overall accuracy of the GAN accelerator 30. Indeed, the approximation error is well within the limit of DIRECTX and OPENGL for Embedded Systems (OPENGL ES) requirements for media applications. Accordingly, embodiments provide an opportunity to reuse the solution across different media workloads. Due to this conversion, traditional convolution operations in the discriminative model 38 and the generative model 36 may be bypassed and replaced by simple element-by-element multiplication operations, which reduces computation requirements.

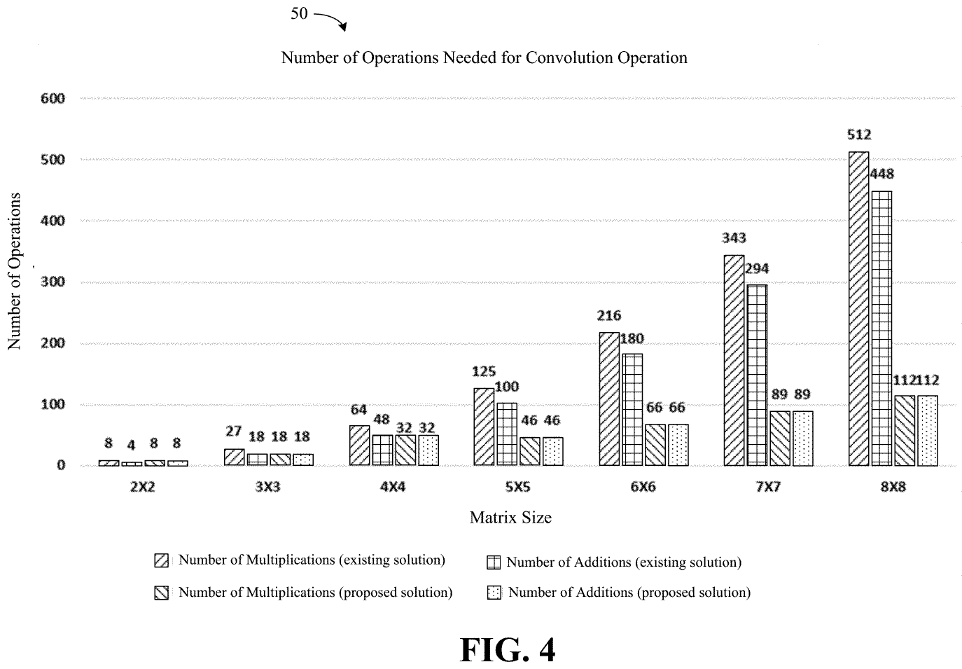

FIG. 4 shows a chart 50 of the number of multiplication and addition operations required for one simple convolution in the time domain and the frequency domain. In the illustrated example, the number of multiplication and addition operations also accounts for conversion of the input data and weights to the frequency domain using the DCT/IDCT CORDIC procedure.

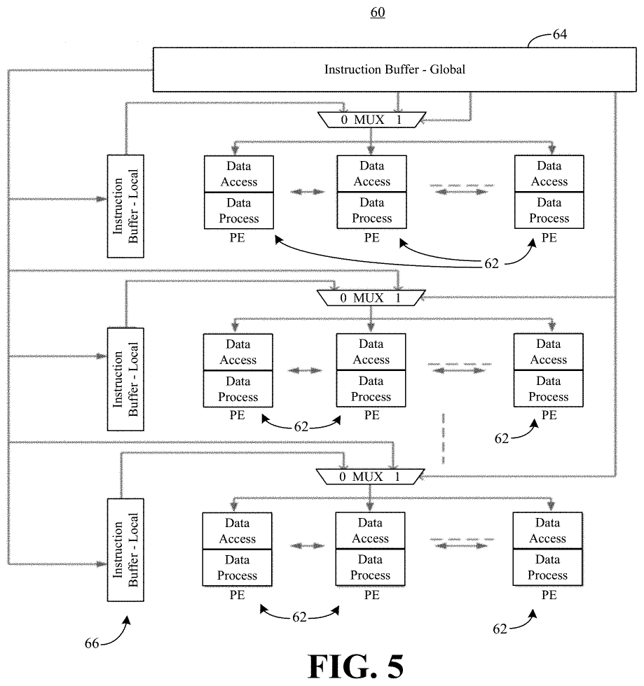

FIG. 5 shows a model architecture 60 that may be readily incorporated into the discriminative model 38 (FIG. 3) and/or the generative model 36 (FIG. 3), already discussed. The illustrated model architecture 60 includes an array of processing elements (PEs) 62 and a global instruction buffer 64 coupled to the array of processing elements 62, wherein the global instruction buffer 64 selectively issues single instruction multiple data (SIMD) instructions to columns in the array of processing elements 62 (e.g., when the input data contains non-zero values). The model architecture 60 may also include a plurality of local instruction buffers 66 coupled to the array of processing elements 62, wherein the plurality of local instruction buffers selectively issue multiple instruction multiple data (MIMD) instructions to rows in the array of processing elements 62 (e.g., when the input data contains zero values). In the illustrated example, a single bit value is passed from the global instruction buffer 64 to enable the PEs 62 in a row via the local instruction buffer 66, otherwise instructions are processed from the global instruction buffer 64. Each PE 62 is capable of handling operations of one stride data. Accordingly, use of MIMD enables these operations on different stride data in parallel.

With regard to stride data, during each iteration of a convolution operation, one input window is selected and multiplied with weights. Once the operation is completed, the input window moves to the next set of inputs. This movement of the input window is called a “stride”. There are two types of strides—a horizontal stride (e.g., where the input window moves horizontally over the next set of inputs) and a vertical stride (e.g., where the input window slides downward). From a larger input matrix dimension such as, for example, an input of size 9×9 and the weights are 3×3, then initially the input window will select first 3×3 elements of the 9×9 input. Moreover, based on the horizontal and vertical stride, the input window will read subsequent 3×3 elements.

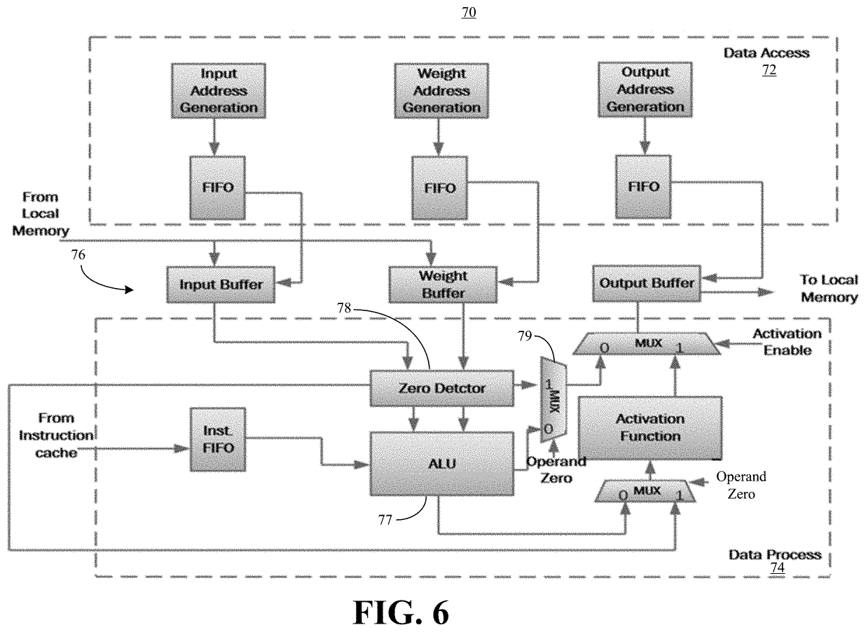

FIG. 6 shows a processing element 70 that may be readily substituted for any of the elements in the array of processing elements 62 (FIG. 5), already discussed. The processing element 70 may include data access hardware 72 to retrieve the input data and data processing hardware 74 to process the retrieved input data. In the illustrated example, the data access hardware 72 is separate from the data processing hardware 74. More particularly, the data access hardware 72 is responsible for memory management and fetching data from memory, while the data processing hardware 74 is responsible for performing operations on that data. Data fetched from memory will be held in buffers 76 (e.g., input, weight, output) until all operations related to those data are done. Zero detection hardware 78 is used to mitigate the ineffectual operations due to zero insertion in the transconv layer.

More particularly, the zero detection hardware 78 is a type of comparator circuit that compares the inputs against the value zero. If a match found for any of the inputs, the entire multiplication output will be tied to the zero value without performing the multiplication operation. In this case, the output of a multiplexer 79 will select the output of the zero detection hardware 78 instead of the output of an arithmetic logic unit (ALU) 77.

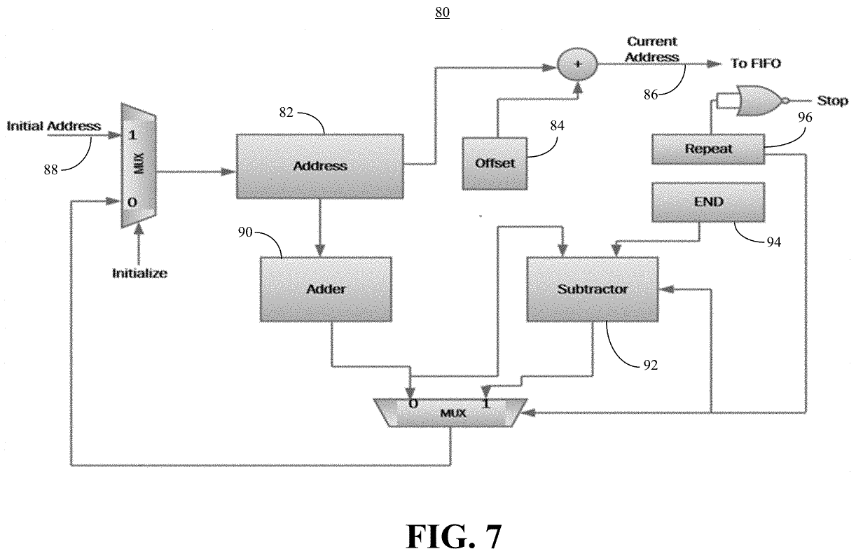

FIG. 7 shows address generation hardware 80 that may be readily incorporated into the data access hardware 72 (FIG. 6), already discussed. In one example, an address block 82 and an offset 84 are used to determine a current address 86 from an initial address 88. Additionally, an adder 90, a subtractor 92, an end block 94, and a repeat block 96 may be used to initialize the address generation hardware 80.

DCT

For a given two-dimensional (2D) spatial data sequence x(i, j), 0≤i, j≤N−1, the corresponding 2D-DCT data sequence X(u, v), 0≤u, v≤N−1, is defined as,

$$X ( u , v ) = \frac{2}{N} C ( u ) C ( v ) {\sum }_{i = 0}^{N - 1} {\sum }_{j = 0}^{N - 1} x ( i , j ) cos \frac{( 2 i + 1 ) u π}{2 N} . cos \frac{( 2 j + 1 ) v π}{2 N} \qquad ( 1 )$$

$$Where ,$$

$$C ( k ) = f ( x ) = \{ \begin{matrix}\frac{1}{\sqrt{2}} , & m = 0 , 0 \leq n \leq N - 1 \\ 1 , & 1 \leq k \leq N - 1\end{matrix} \qquad ( 2 )$$

And the corresponding IDCT is given as:

$$x ( i , j ) = \frac{2}{N} C ( u ) C ( v ) {\sum }_{i = 0}^{N - 1} {\sum }_{j = 0}^{N - 1} X ( u , v ) cos \frac{( 2 i + 1 ) u π}{2 N} . cos \frac{( 2 j + 1 ) v π}{2 N} \qquad ( 3 )$$

$$Where ,$$

$$C ( k ) = f ( x ) = \{ \begin{matrix}\frac{1}{\sqrt{2}} , & m = 0 , 0 \leq n \leq N - 1 \\ 1 , & 1 \leq k \leq N - 1\end{matrix} \qquad ( 4 )$$

As both equations are very similar, the same hardware can be used for DCT and IDCT. From above equations, cosine term computations are implemented using the CORDIC procedure, which is an iterative solution.

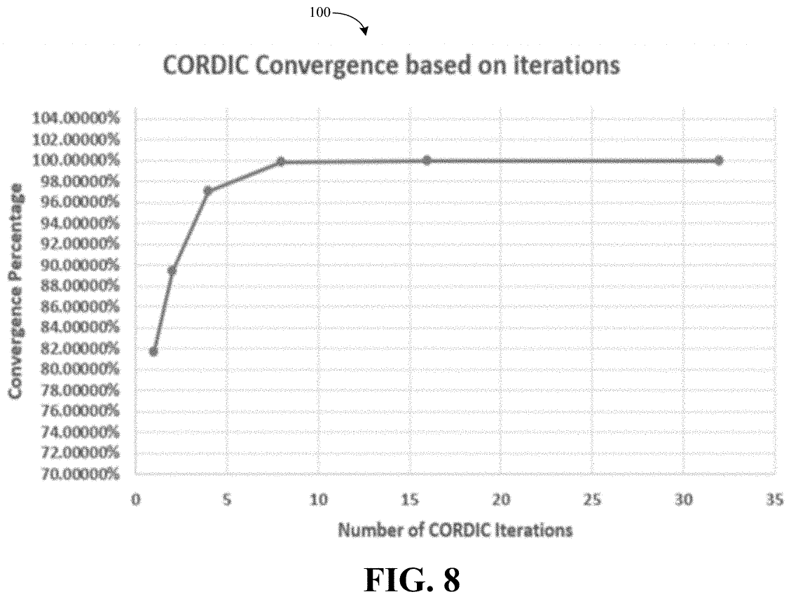

FIG. 8 shows a chart 100 in which the cosine term value converges after multiple iterations. To reduce latency, this iterative solution may be implemented in a systolic array form.

The proposed DCT/IDCT solution enables the precision to be scaled based on application requirements. If an application demands higher precision, the scaling factor involved in the CORDIC implementation can be replaced with actual cosine values. The scaling factor of CORDIC algorithm can be calculated as follows.

$$Scaling factor K = \frac{1}{\sqrt{1 + {2}^{- 2 i}}} \qquad ( 5 )$$

Where, i is number of stages (e.g., iterations) in CORDIC.

Therefore, the greater the number of CORDIC iterations, the better the convergence. In one example, eight stages of CORDIC iterations are used to improve accuracy. If the application does not require greater accuracy, then the number of CORDIC iterations can be reduced to save area and latency.

The CORDIC procedure can be given as:

$$[ \begin{matrix}{x}_{i} \\ {y}_{i}\end{matrix} ] = scaling factor K * ( [ \begin{matrix}1 & - {2}^{- i} \\ {2}^{- i} & 1\end{matrix} ] * [ \begin{matrix}{x}_{i - 1} \\ {y}_{i - 1}\end{matrix} ] ) \qquad ( 6 )$$

$$And ,$$

$$Scaling factor K = \frac{1}{\sqrt{1 + {2}^{- 2 i}}} \qquad ( 7 )$$

Where, i=iteration number.

The scaling factor K is multiplied with the last CORDIC stage only, to reduce the number of multipliers in the implementation.

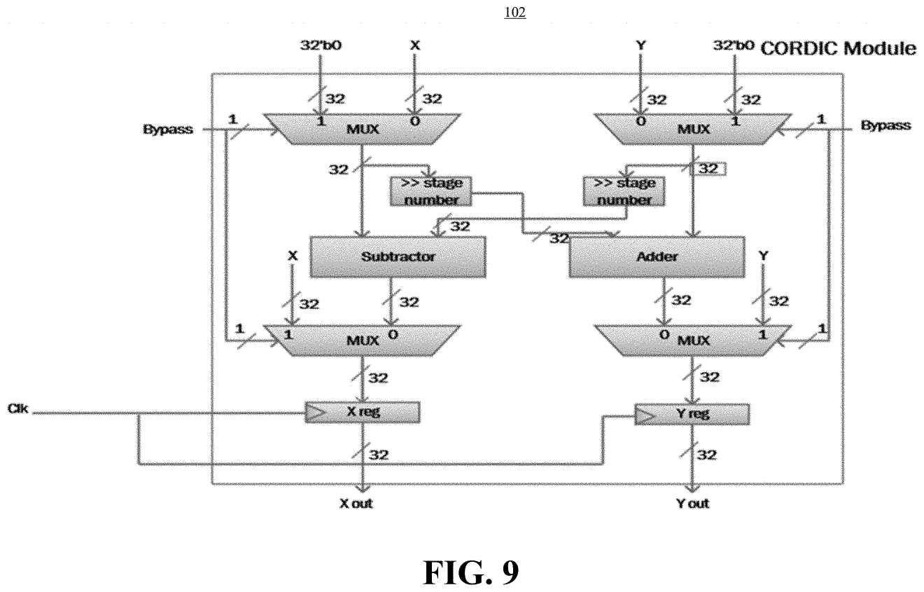

FIG. 9 shows CORDIC hardware 102 to perform the matrix multiplication in equation (6). In an embodiment, the CORDIC hardware 102 provides a cell or node that is useful in implementing the cosine operation by a systolic array circuit.

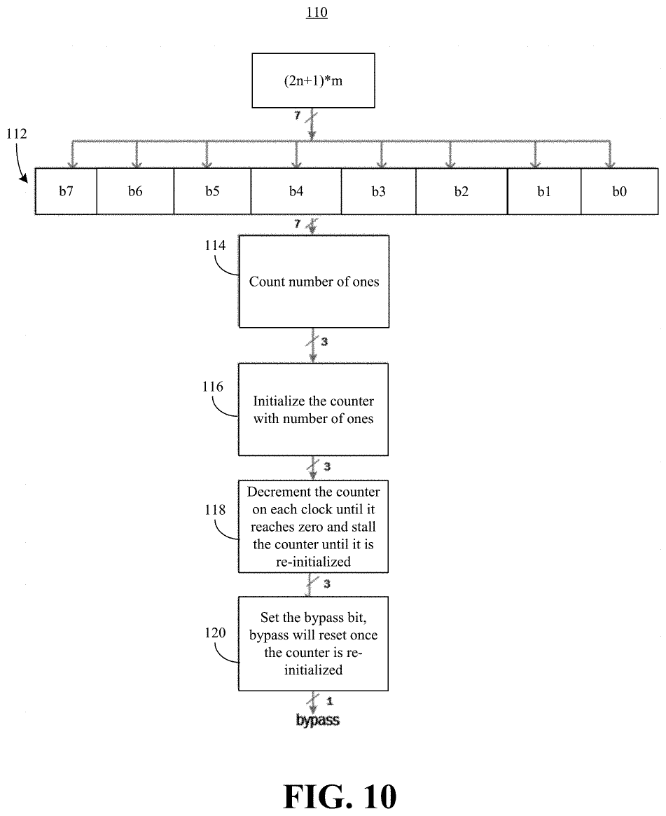

FIG. 10 shows a method 110 of setting bypass bits for a scenario in which N=8 for an N×N operation. If m=0, the cosine term is eliminated as cos (0)=1. Accordingly,

$$the cos [ ( max value ) * \frac{π}{2 N} ] m =$$

that can come from equations (1) and (3) is 135 (n=7 and m=7). This example can be accommodated in an 8-bit vector 112. Processing block 114 counts the number of ones in the vector 112, wherein the number of ones provides what is the minimum number of CORDIC stages needed for the convergence. Block 116 initializes a counter with the number of ones and block 118 decrements the counter on each clock cycle until the counter reaches zero. At that moment, block 118 stalls the counter until the counter is re-initialized. Block 120 sets the bypass bit, which will be reset when the counter is re-initialized. Thus, once convergence is achieved, remaining CORDIC stages can be bypassed for reducing toggles in further stages as the remaining CORDIC stages will not produce any further improvement. This approach reduces power consumption.

FIG. 11 demonstrates that the CORDIC modules may be grouped and implemented in a systolic array 130 having a plurality of multipliers 132 as a last stage, wherein the multipliers 132 multiply the resultant by the scaling factor. More particularly, the systolic array 130 includes a plurality of CORDIC arrays, each of the CORDIC arrays incorporating a plurality of CORDIC modules (e.g., circuit stages), such as the CORDIC hardware 102 (FIG. 9), in accordance with at least one embodiment described herein. Each of the CORDIC arrays receives a respective input signal (“Input 1” to “Input 8”) and a respective clock signal (“Clk 1” to “Clk 8”). Each of the CORDIC modules forming each of the CORDIC arrays receives a respective bypass signal (e.g., from “Bypass Logic”). Each of the CORDIC arrays includes a respective multiplier circuit in the multipliers 132 that multiplies the resultant value generated by the CORDIC array by a multiplier constant value (e.g., from “Multiplier Input Logic”). The systolic array 130 (e.g., DCT/IDCT system) generates a systolic array output matrix (“Output 1”).

In embodiments, each of the inputs passes through a number of CORDIC modules. The number of CORDIC modules through which each input passes may, in some embodiments, be based upon the desired precision of the values included in the systolic array output matrix. Upon achieving a targeted level of precision and/or accuracy in the values for inclusion in the systolic array output matrix, the bypass signal causes the termination of the CORDIC procedure on the respective input value. The multipliers 132 then multiply the resultant value provided by the CORDIC array by the constant value. The resultant scaled cosine/arccosine value is then forwarded for inclusion in the systolic array output matrix.

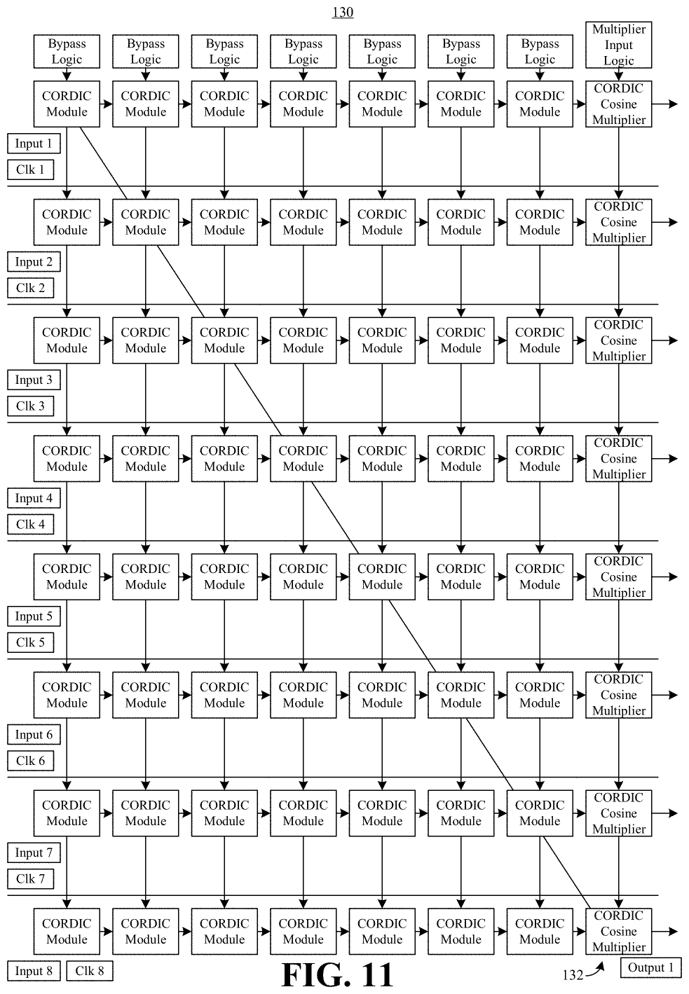

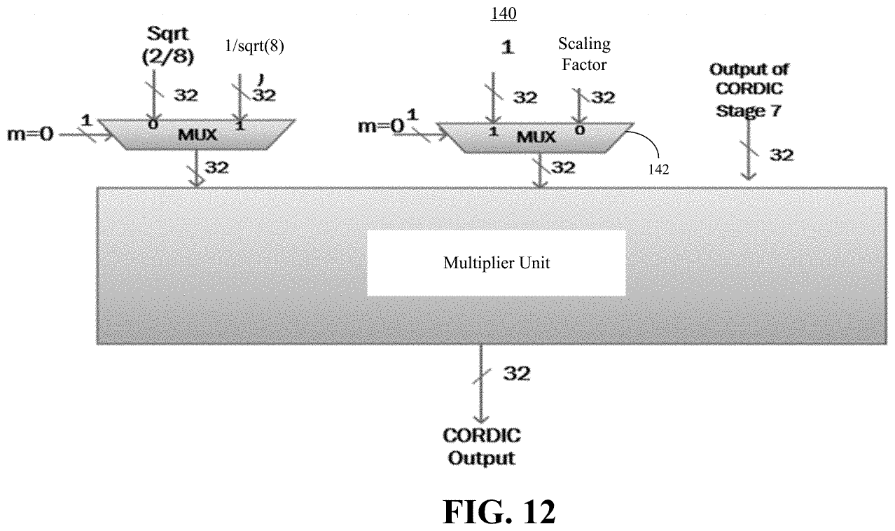

FIG. 12 shows one example of a multiplier unit 140 that may be readily substituted for each of the plurality of multipliers 132 (FIG. 11), already discussed. In the illustrated example, multiplier unit 140 receives a scaling factor as an input. If m=0, the cosine term is eliminated as cos (0)=1. In an embodiment, a multiplexer (mux) 142 is used to separate this condition.

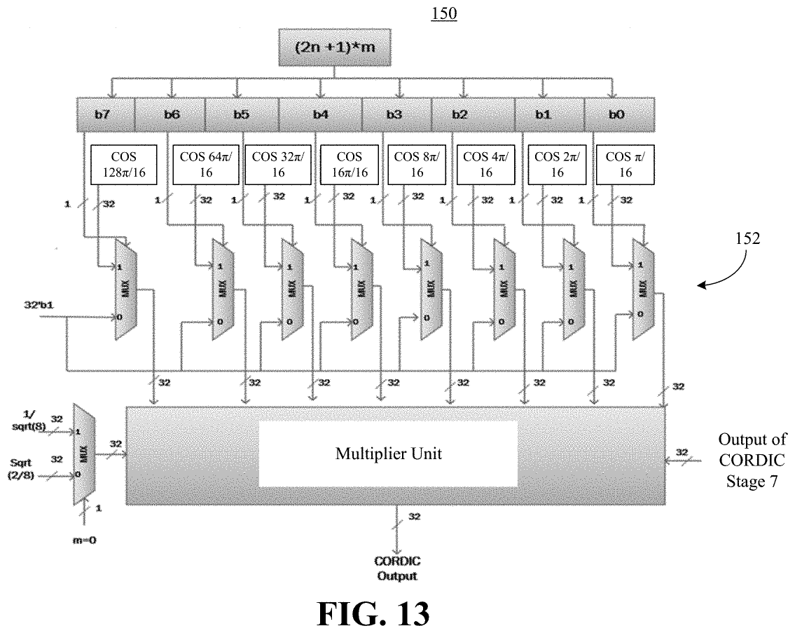

FIG. 13 shows another example of a multiplier unit 150 that may be readily substituted for each of the plurality of multipliers 132 (FIG. 11), already discussed. This configuration may be used when the application demands greater accuracy. In this example, actual cosine values are computed and stored rather than a scaling factor. The cosine values are selected through a set of multiplexers 152 based on 8-bit values (e.g., considering a case of N=8). The multiplier unit 150 is larger than the scaling factor configuration of FIG. 12. The larger size may also have a negative impact on latency.

The output of the CORDIC systolic array will have multiple cosine terms, which may be stored in a matrix fashion.

For example, for N=8, the CORDIC systolic array output will be two 8×1 matrix of cosine values (e.g., “T” and “T1”).

Taking the transpose of T1 and performing matrix multiplication with T and x (i, j), provides:

$$J 8 X 8 = T 8 X 1 * T 1 T 1 \times 8 \qquad ( 8 )$$

$$Finally ,$$

$$X ( u , v ) 8 \times 8 = \frac{2}{N} ( J 8 \times 8 * x ( i , j ) 8 \times 8 ) \qquad ( 9 )$$

$$Similarity , for IDCT ,$$

$$x ( i , j ) 8 \times 8 = \frac{2}{N} ( J 8 \times 8 * X ( u , v ) 8 \times 8 ) \qquad ( 10 )$$

DCT Implementation

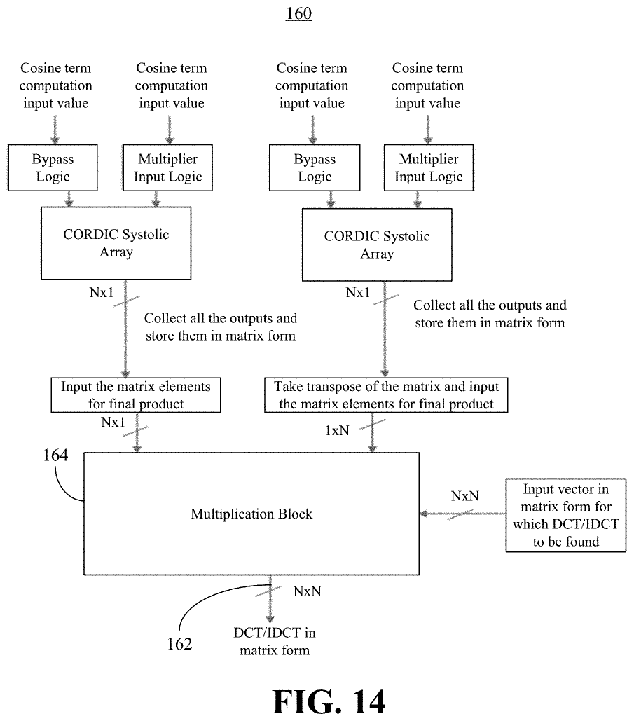

FIG. 14 shows DCT hardware 160 that generates two output matrices, which are multiplied to obtain an intermediate block matrix. This intermediate block matrix is used to generate a final result of DCT/IDCT by multiplying the intermediate block matrix with the input matrix x/X, respectively. The DCT hardware 160 uses a single multiplication block 164 without any memory to perform the described operations. Eliminating the use of memory and look-up tables (LUTs) significantly reduces the number of cycles required for the operations. Moreover, the initial latency of systolic arrays is comparable with conventional solutions.

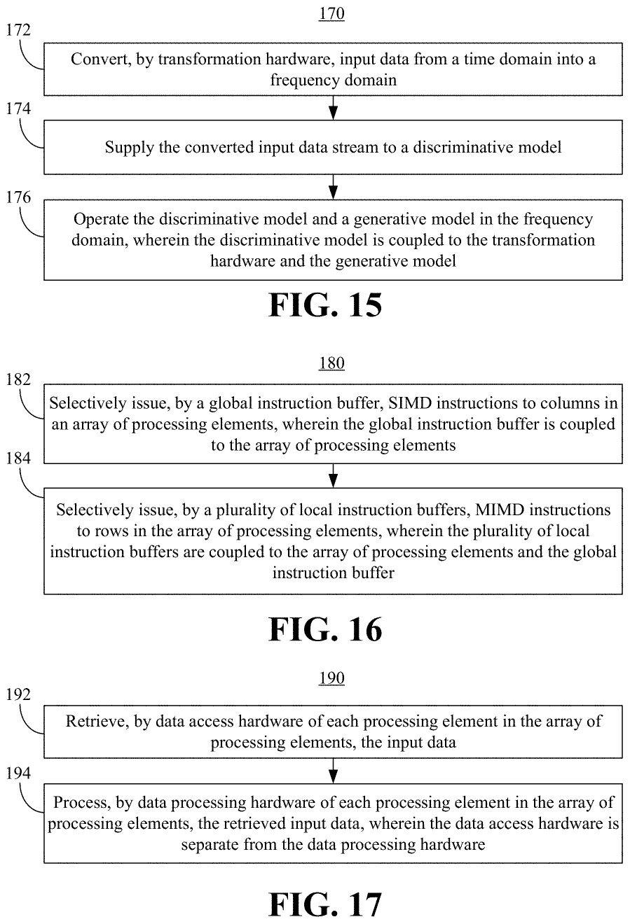

FIG. 15 shows a method 170 of operating a GAN accelerator. The method 170 may generally be implemented in a GAN accelerator such as, for example, the GAN accelerator 30 (FIG. 3), already discussed. More particularly, the method 170 may be implemented as hardware in configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Illustrated processing block 172 converts, by transformation hardware, input data from a time domain into a frequency domain, wherein block 174 supplies the converted input data to a discriminative model (e.g., discriminative DNN). Block 176 operates the discriminative model and a generative model of the GAN accelerator in the frequency domain. In the illustrated example, the discriminative model is coupled to the transformation hardware and the generative model. Block 176 may include inserting, by a random number generator coupled to the generative model, zero values into an output to the generative model.

The method 170 therefore enhances performance at least to the extent that operating the discriminative model and the generative model in the frequency domain includes element-by-element multiplication operations and/or bypasses one or more convolution operations, which in turn reduces latency without having a negative impact on accuracy. Indeed, the reduced latency may enhance the convergence of the models (e.g., enabling the GAN accelerator to reach global minima more quickly).

FIG. 16 shows a method 180 of operating model architecture. The method 180 may generally be implemented in a model architecture such as, for example, the model architecture 60 (FIG. 5), already discussed. More particularly, the method 180 may be implemented as hardware in configurable logic, fixed-functionality logic, or any combination thereof.

Illustrated processing block 182 provides for selectively issuing, by a global instruction buffer, SIMD instructions to columns in an array of processing elements, wherein the global instruction buffer is coupled to the array of processing elements. Block 182 may be particularly advantageous when the input data contains non-zero values. Block 184 selectively issues, by a plurality of local instruction buffers, MIMD instructions to rows (e.g., wherein each row corresponds to a model layer) in the array of processing elements. In the illustrated example, the plurality of local instruction buffers are coupled to the array of processing elements and the global instruction buffer. Block 184 may be particularly advantageous when the input data contains zero values. The method 180 therefore further enhances performance at least to the extent that the use of optimized SIMD-MIMD processing elements reduces the compute imbalance and ineffectual operations associated with zero insertion (e.g., increasing efficiency).

FIG. 17 shows a method 190 of operating a processing element. The method 190 may generally be implemented in a processing element such as, for example, the processing element 70 (FIG. 6), already discussed. More particularly, the method 190 may be implemented as hardware in configurable logic, fixed-functionality logic, or any combination thereof.

Illustrated processing block 192 provides for retrieving, by data access hardware of each processing element in an array of processing elements, input data. Block 194 processes, by data processing hardware of each processing element in the array of processing elements, the retrieved input data, wherein the data access hardware is separate from the data processing hardware. In one example, block 194 includes detecting, by zero detection hardware, zero values in the input data. The method 190 therefore further enhances performance at least to the extent that separate data processing and data fetching facilitates the use of a specific set of operations in each processing element.

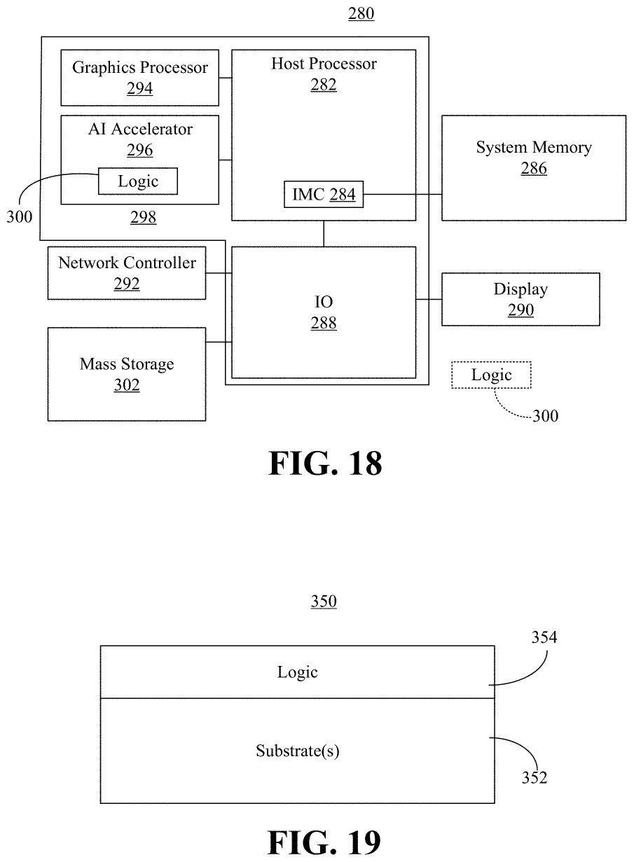

Turning now to FIG. 18, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). In one example, the network controller 292 obtains input data. The host processor 282 may be combined with the IO module 288, a graphics processor 294, and an AI accelerator 296 into a system on chip (SoC) 298.

In an embodiment, the AI accelerator 296 includes the GAN accelerator 30 (FIG. 3), already discussed. Thus, the AI accelerator 296 may include logic 300 that performs one or more aspects of the method 170 (FIG. 15), the method 180 (FIG. 16) and/or the method 190 (FIG. 17), already discussed. The logic 300 may therefore include transformation hardware to convert the input data from a time domain into a frequency domain, a generative model, and a discriminative model coupled to the transformation hardware and the generative model, wherein the generative model and the discriminative model operate in the frequency domain. Although the logic 300 is shown within the AI accelerator 296, the logic 300 may also reside elsewhere in the computing system 280

The computing system 280 is therefore considered performance-enhanced at least to the extent that operating the discriminative model and the generative model in the frequency domain includes element-by-element multiplication operations and/or bypasses one or more convolution operations, which in turn reduces latency without having a negative impact on accuracy. Indeed, the reduced latency may enhance the convergence of the models (e.g., enabling the GAN accelerator to reach global minima more quickly).

FIG. 19 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. The logic 354 may be readily substituted for the logic 300 (FIG. 18), already discussed. In an embodiment, the logic 354 implements one or more aspects of the method 170 (FIG. 15), the method 180 (FIG. 16) and/or the method 190 (FIG. 17), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

Embodiments therefore provide an enhanced hardware architecture for GAN with optimized processing engines (PEs). The proposed architecture separates data access and data processing for each PE, which helps in using specific set of operations across each PE as per the requirement. PEs are arranged in a 2D array in the proposed architecture. This architecture uses the benefits of SIMD and MIMD execution models to avoid inefficient operations and compute imbalances. To achieve this improvement, two sets of instruction buffers are employed, global and local. Instruction buffer—global is needed to program all PEs across all rows with same instruction in a SIMD mode. To utilize the resources to their full extent instruction buffer—local is used, such that proposed solution can utilize the benefits of MIMD along with SIMD. A single bit value is passed from the instruction buffer—global to enable the PEs in a row with the instruction buffer—local, otherwise, instructions will be processed from the instruction buffer—global.

Inefficiencies caused by zero insertion in a GAN are addressed by using a zero-detector block inside each PE. In one example, each PE is implemented with synthesis gates. To reduce the overall computation requirements, a small labelled input data set of the discrimination model is converted to the frequency domain using an optimized custom Discrete Cosine Transform (DCT) block. As a result, the generative model, which is attempting to generate new samples from the real data samples, will start generating samples in the frequency domain. Moreover, the conversion to frequency domain reduces the number of multiplication and addition requirements substantially. Unlike traditional DNNs, the frequency domain conversion overhead is minimal as GANs automatically generate larger and richer datasets from a small labeled set (e.g., making GANs suitable for the prosed solution).

To reduce overhead further, a custom DCT block based on CORDIC procedures is used to implement the cosine function in the DCT computation. In one example, the CORDIC procedure with an iteration of eight stages increases accuracy. Due to the simplified implementation of CORDIC using a systolic array, computation takes only 2N−1 clock cycles to compute cosine value for N×N DCT. These results are achieved with a relatively low approximation error due to the use of a scaling factor in CORDIC, which does not degrade the overall accuracy of the GAN.

### Additional Notes and Examples

Example 1 includes a performance-enhanced computing system comprising a network controller to obtain input data and a generative adversarial network (GAN) accelerator coupled to the network controller, wherein the GAN accelerator includes logic coupled to one or more substrates, the logic including transformation hardware to convert the input data from a time domain to a frequency domain, a generative model, and a discriminative model coupled to the transformation hardware and the generative model, wherein the generative model and the discriminative model are to operate in the frequency domain.

Example 2 includes the computing system of Example 1, wherein operation of the generative model and the discriminative model in the frequency domain includes element-by-element multiplication operations.

Example 3 includes the computing system of Example 1, wherein operation of the generative model and the discriminative model in the frequency domain bypasses one or more convolution operations.

Example 4 includes the computing system of Example 1, wherein one or more of the generative model or the discriminative model include an array of processing elements, a global instruction buffer coupled to the array of processing elements, wherein the global instruction buffer is to selectively issue single instruction multiple data (SIMD) instructions to columns in the array of processing elements, and a plurality of local instruction buffers coupled to the array of processing elements and the global instruction buffer, wherein the plurality of local instruction buffers are to selectively issue multiple instruction multiple data (MIMD) instructions to rows in the array of processing elements.

Example 5 includes the computing system of Example 4, wherein each processing element in the array of processing elements includes data access hardware to retrieve the input data and data processing hardware to process the retrieved input data, and wherein the data access hardware is separate from the data processing hardware.

Example 6 includes the computing system of Example 5, wherein each data processing hardware includes zero detection hardware to detect zero values in the input data.

Example 7 includes the computing system of any one of Examples 1 to 6, further including a random number generator coupled to the generative model, wherein the random number generator is to insert zero values into an output to the generative model.

Example 8 includes the computing system of any one of Examples 1 to 7, further including a loss function generator coupled to the discriminative model and the generative model.

Example 9 includes a generative adversarial network (GAN) accelerator comprising one or more substrates, and logic coupled to the one or more substrates, wherein the logic is implemented at least partly in one or more of configurable or fixed-functionality hardware, the logic including transformation hardware to convert input data from a time domain into a frequency domain, a generative model, and a discriminative model coupled to the transformation hardware and the generative model, wherein the generative model and the discriminative model are to operate in the frequency domain.

Example 10 includes the GAN accelerator of Example 9, wherein operation of the generative model and the discriminative model in the frequency domain includes element-by-element multiplication operations.

Example 11 includes the GAN accelerator of Example 9, wherein operation of the generative model and the discriminative model in the frequency domain bypasses one or more convolution operations.

Example 12 includes the GAN accelerator of Example 9, wherein one or more of the generative model or the discriminative model include an array of processing elements, a global instruction buffer coupled to the array of processing elements, wherein the global instruction buffer is to selectively issue single instruction multiple data (SIMD) instructions to columns in the array of processing elements, and a plurality of local instruction buffers coupled to the array of processing elements and the global instruction buffer, wherein the plurality of local instruction buffers are to selectively issue multiple instruction multiple data (MIMD) instructions to rows in the array of processing elements.

Example 13 includes the GAN accelerator of Example 12, wherein each processing element in the array of processing elements includes data access hardware to retrieve the input data and data processing hardware to process the retrieved input data, and wherein the data access hardware is separate from the data processing hardware.

Example 14 includes the GAN accelerator of Example 13, wherein each data processing hardware includes zero detection hardware.

Example 15 includes the GAN accelerator of any one of Examples 9 to 14, further including a random number generator coupled to the generative model, wherein the random number generator is to insert zero values into an output to the generative model.

Example 16 includes the GAN accelerator of any one of Examples 9 to 15, further including a loss function generator coupled to the discriminative model and the generative model.

Example 17 includes the GAN accelerator of any one of Examples 9 to 15, wherein the logic coupled to the one or more substrates includes transistor channel regions that are positioned within the one or more substrates.

Example 18 includes a method of operating a generative adversarial network (GAN) accelerator, the method comprising converting, by transformation hardware, input data from a time domain into a frequency domain, supply the converted input data to a discriminative model, and operate the discriminative model and a generative model in the frequency domain, wherein the discriminative model is coupled to the transformation hardware and the generative model.

Example 19 includes the method of Example 18, wherein operation of the generative model and the discriminative model in the frequency domain includes element-by-element multiplication operations.

Example 20 includes the method of Example 18, wherein operation of the generative model and the discriminative model in the frequency domain bypasses one or more convolution operations.

Example 21 includes the method of Example 18, further including selectively issuing, by a global instruction buffer, single instruction multiple data (SIMD) instructions to columns in an array of processing elements, wherein the global instruction buffer is coupled to the array of processing elements, and selectively issuing, by a plurality of local instruction buffers, multiple instruction multiple data (MAID) instructions to rows in the array of processing elements, wherein the plurality of local instruction buffers are coupled to the array of processing elements and the global instruction buffer.

Example 22 includes the method of Example 21, further including retrieving, by data access hardware of each processing element in the array of processing elements, input data, and processing, by data processing hardware of each processing element in the array of processing elements, the retrieved input data, wherein the data access hardware is separate from the data processing hardware.

Example 23 includes the method of Example 22, further including detecting, by zero detection hardware, zero values in the input data.

Example 24 includes the method of any one of Examples 18 to 23, further including, inserting, by a random number generator coupled to the generative model, zero values into an output to the generative model.

Example 25 includes an apparatus comprising means for performing the method of any one of Examples 18 to 24.

Technology described herein therefore provides an end-to-end hardware architecture solution to accelerate GANs. The technology also enables GAN operation in the frequency domain, wherein a small labelled input data set of a discrimination model is converted to the frequency domain using an optimized DCT block. Due to this conversion, traditional convolution operations are replaced by simple element-by-element multiplication, which reduces computational requirements. Additionally, the technology implements an DCT/IDCT block using CORDIC and a scaling factor. As a result, a relatively low approximation error is achieved and overall accuracy of the GAN is maintained. Moreover, the technology described herein includes processing engines with separate data processing and data fetching. This approach helps in using a specific set of operations in each PE. In addition, the technology harnesses the benefits of SIMD and MIMD in the processing engines. Accordingly, inefficient operations are avoided. Moreover, a zero detector block is used to mitigate the ineffectual operations resulting from to zero insertion in the transconv layer. PEs are arranged in a 2D array, wherein all PEs in a single row operate under a SIMD model and each row operates under a MIMD model to achieve parallel execution. The technology is also portable to any DNN without any dependency or modification. The approximation error is well within the limit of DIRECTX and OPENGL ES requirement for media applications, which provides an opportunity to reuse the solution across different media workloads as well.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller to obtain input data; and
a generative adversarial network (GAN) accelerator coupled to the network controller, wherein the GAN accelerator includes logic coupled to one or more substrates, the logic including:
transformation hardware to convert the input data from a time domain into a frequency domain,
a generative model, and
a discriminative model coupled to the transformation hardware and the generative model, wherein the generative model and the discriminative model are to operate in the frequency domain.

2. The computing system of claim 1, wherein operation of the generative model and the discriminative model in the frequency domain includes element-by-element multiplication operations.

3. The computing system of claim 1, wherein operation of the generative model and the discriminative model in the frequency domain bypasses one or more convolution operations.

4. The computing system of claim 1, wherein one or more of the generative model or the discriminative model include:
an array of processing elements,
a global instruction buffer coupled to the array of processing elements, wherein the global instruction buffer is to selectively issue single instruction multiple data (SIMD) instructions to columns in the array of processing elements, and
a plurality of local instruction buffers coupled to the array of processing elements and the global instruction buffer, wherein the plurality of local instruction buffers are to selectively issue multiple instruction multiple data (MIMD) instructions to rows in the array of processing elements.

5. The computing system of claim 4, wherein each processing element in the array of processing elements includes data access hardware to retrieve the input data and data processing hardware to process the retrieved input data, and wherein the data access hardware is separate from the data processing hardware.

6. The computing system of claim 5, wherein each data processing hardware includes zero detection hardware to detect zero values in the input data.

7. The computing system of claim 1, further including a random number generator coupled to the generative model, wherein the random number generator is to insert zero values into an output to the generative model.

8. The computing system of claim 1, further including a loss function generator coupled to the discriminative model and the generative model.

9. A generative adversarial network (GAN) accelerator comprising:
one or more substrates; and
logic coupled to the one or more substrates, wherein the logic is implemented at least partly in one or more of configurable or fixed-functionality hardware, the logic including:
transformation hardware to convert input data from a time domain into a frequency domain;
a generative model; and
a discriminative model coupled to the transformation hardware and the generative model, wherein the generative model and the discriminative model are to operate in the frequency domain.

10. The GAN accelerator of claim 9, wherein operation of the generative model and the discriminative model in the frequency domain includes element-by-element multiplication operations.

11. The GAN accelerator of claim 9, wherein operation of the generative model and the discriminative model in the frequency domain bypasses one or more convolution operations.

12. The GAN accelerator of claim 9, wherein one or more of the generative model or the discriminative model include:
an array of processing elements;
a global instruction buffer coupled to the array of processing elements, wherein the global instruction buffer is to selectively issue single instruction multiple data (SIMD) instructions to columns in the array of processing elements; and
a plurality of local instruction buffers coupled to the array of processing elements and the global instruction buffer, wherein the plurality of local instruction buffers are to selectively issue multiple instruction multiple data (MIMD) instructions to rows in the array of processing elements.

13. The GAN accelerator of claim 12, wherein each processing element in the array of processing elements includes data access hardware to retrieve the input data and data processing hardware to process the retrieved input data, and wherein the data access hardware is separate from the data processing hardware.

14. The GAN accelerator of claim 13, wherein each data processing hardware includes zero detection hardware.

15. The GAN accelerator of claim 9, further including a random number generator coupled to the generative model, wherein the random number generator is to insert zero values into an output to the generative model.

16. The GAN accelerator of claim 9, further including a loss function generator coupled to the discriminative model and the generative model.

17. The GAN accelerator of claim 9, wherein the logic coupled to the one or more substrates includes transistor channel regions that are positioned within the one or more substrates.

18. A method comprising:
converting, by transformation hardware, input data from a time domain into a frequency domain;
supply the converted input data to a discriminative model; and
operate the discriminative model and a generative model in the frequency domain, wherein the discriminative model is coupled to the transformation hardware and the generative model.

19. The method of claim 18, wherein operation of the generative model and the discriminative model in the frequency domain includes element-by-element multiplication operations.

20. The method of claim 18, wherein operation of the generative model and the discriminative model in the frequency domain bypasses one or more convolution operations.

21. The method of claim 18, further including:
selectively issuing, by a global instruction buffer, single instruction multiple data (SIMD) instructions to columns in an array of processing elements, wherein the global instruction buffer is coupled to the array of processing elements; and
selectively issuing, by a plurality of local instruction buffers, multiple instruction multiple data (MIMD) instructions to rows in the array of processing elements, wherein the plurality of local instruction buffers are coupled to the array of processing elements and the global instruction buffer.

22. The method of claim 21, further including:
retrieving, by data access hardware of each processing element in the array of processing elements, input data; and
processing, by data processing hardware of each processing element in the array of processing elements, the retrieved input data, wherein the data access hardware is separate from the data processing hardware.

23. The method of claim 22, further including detecting, by zero detection hardware, zero values in the input data.

24. The method of claim 18, further including, inserting, by a random number generator coupled to the generative model, zero values into an output to the generative model.
